(19) United States
(12) Patent Application Publication
(10) Pub. No.: US 2006/0182158 A1
(43) Pub. Date: Aug. 17, 2006

(54) Information recording reproduction apparatus and information reproduction method

(75) Inventors: Kiyoshi Tateishi, Tsurugashima-Shi (JP); Junichi Furukawa, Tokorozawa-Shi (JP)

Correspondence Address: YOUNG & THOMPSON, 745 SOUTH 23RD STREET, 2ND FLOOR, ARLINGTON, VA, 22202, US

(73) Assignee: PIONEER CORPORATION, TOKYO (JP)

(21) Appl. No.: 11/352,322

(22) Filed: Feb. 13, 2006

(30) Foreign Application Priority Data
Feb. 14, 2005 (JP) 2005-035905

(51) Int. Cl. H01S 3/00

(52) U.S. Cl. 372/38.02; 372/38.01; 372/38.07

(57) ABSTRACT

An information recording reproduction apparatus includes a laser light source, a laser driving unit which supplies a laser driving signal to the laser light source to make it emit a laser light for recording and reproduction, a high frequency superimposing unit which superimposes a high frequency signal to a laser driving signal and a duty controlling unit which controls a duty ratio of the high frequency signal. The high frequency superimposing unit superimposes the high frequency signal on the laser driving signal driving the laser light source in order to prevent an effect due to a return light from an optical disc. The duty controlling unit controls the duty ratio of the high frequency signal so that generation of a higher harmonic component in the high frequency signal is decreased or so that the duty ratio becomes approximately 50%, for example.

### BACKGROUND OF THE INVENTION

1. Field of the Invention

The present invention relates to an information recording reproduction apparatus and an information reproduction method which record and reproduce information onto and from an optical disc.

2. Description of Related Art

Conventionally, it is known that a reproduction characteristic of data is deteriorated because oscillation of a laser diode becomes unstable due to irradiation of a return light from an optical disc onto an emission surface of the laser diode and a noise (laser noise) is generated. As a countermeasure, there is known a technique for reducing the generation of the above-mentioned laser noise by superimposing a high frequency signal (i.e., high frequency superimposition) on a signal driving the laser diode thereby to oscillate the laser diode in a multimode.

In this case, by executing the above-mentioned high frequency superimposition, the laser noise can be reduced. However, unnecessary radiation caused by the high frequency signal increases, and electro magnetic interference (EMI) sometimes occurs on other apparatuses. Therefore, there is used a technique for electromagnetically shielding a circuit (i.e., high frequency superimposing circuit) oscillating the high frequency signal in order to reduce the electro magnetic interference (e.g., see Japanese Patent Application Laid-open under No. 2002-329343).

By the way, recently, by a high-speed transmission rate of data and a high-speed reading speed of the data, a frequency band of reproduction data tends to be wide. An oscillating frequency of the above-mentioned high frequency signal has to be set so that no effect is given to the frequency band of the reproduction data for the purpose of realizing separation of the frequency of the high frequency signal and the frequency band of the reproduction data. Therefore, if the frequency band of the reproduction data becomes wide, the frequency of the high frequency signal has to be set to a much higher frequency.

However, when the frequency of the high frequency signal is so high, even if the high frequency superimposing circuit is electromagnetically shielded as shown by the technique disclosed in Japanese Patent Applications Laid-open under No. 2002-329343, an effect thereof becomes small, and the unnecessary radiation sometimes increases. For example, since a frequency of a fundamental wave of a high frequency signal currently widely used is several hundreds MHz and a frequency of a secondary (second-order) higher harmonic of the high frequency signal is in an order of GHz, only the electromagnetic shielding cannot sometimes sufficiently suppress the unnecessary radiation due to the secondary higher harmonic.

### SUMMARY OF THE INVENTION

The present invention has been achieved in order to solve the above problems. It is an object of this invention to provide an information recording reproduction apparatus and an information reproduction method capable of effectively reducing unnecessary radiation caused by the high frequency superimposition by controlling a duty ratio of a high frequency signal superimposed on a driving signal of a laser light source.

According to one aspect of the present invention, there is provided an information recording reproduction apparatus including: a laser light source; a laser driving unit which supplies a laser driving signal to the laser light source to make the laser light source emit a laser light for recording and reproduction; a high frequency superimposing unit which superimposes a high frequency signal on the laser driving signal; and a duty controlling unit which controls a duty ratio of the high frequency signal.

The above information recording reproduction apparatus is preferably used in order to record information on an optical disc and reproduce the information recorded on the optical disc. The high frequency superimposing unit superimposes the high frequency signal on the driving signal driving the laser light source in order to suppress a laser noise of the laser light source (e.g., laser diode) generated by a return light from the optical disc. Thereby, since the laser diode oscillates in a multimode, instability due to the return light from the optical disc is removed, and the oscillating state becomes stable. Further, the duty controlling unit controls the duty ratio in oscillating the high frequency signal. Specifically, the duty controlling unit executes the control so that the duty ratio of the high frequency signal is set to a predetermined value. Thereby, it becomes possible to reduce the generation of the unnecessary radiation due to the high frequency signal.

In a manner of the above information recording reproduction apparatus, the duty controlling unit may control the duty ratio so that generation of a higher harmonic component due to the high frequency signal is decreased.

In this manner, the duty controlling unit controls the duty ratio so that the generation of the higher harmonic component such as a secondary higher harmonic due to the high frequency signal is reduced. For example, when the frequency of a fundamental wave of the high frequency signal is several hundreds MHz, since the frequency of the secondary higher harmonic of the high frequency signal becomes an order of GHz, it can be said that the generation of the unnecessary radiation is mainly caused by the secondary higher harmonic. Therefore, by controlling the duty ratio to reduce the generation of the higher harmonic component, it becomes possible to effectively reduce the generation of the unnecessary radiation.

In another manner, the information recording reproduction apparatus may further include a duty detecting unit which detects a present duty ratio of the high frequency signal, and the duty controlling unit may control a duty ratio so that the duty ratio detected by the duty detecting unit coincides with a predetermined target duty ratio.

In this manner, the duty detecting unit detects the present duty ratio of the high frequency signal, and the duty controlling unit obtains the predetermined target duty ratio and compares the duty ratio detected by the duty detecting unit and the target duty ratio to control the duty ratio. In this case, the target duty ratio is set to the duty ratio at which the level of the higher harmonic component due to the high frequency signal becomes minimum. Thus, by executing the control for making the duty ratio coincide with the target duty ratio, the generation of the higher harmonic can be decreased, and the unnecessary radiation can be effectively reduced. Moreover, it also becomes possible to prevent that the duty ratio is shifted from the target duty ratio due to aged variation and temperature change.

In still another manner of the above information recording reproduction apparatus, the target duty ratio may be set to substantially 50%.

In this manner, between the duty ratio and the power of the higher harmonic, there is such a relation that the power of the higher harmonic is minimum when the duty ratio is approximately 50% and that the power of the higher harmonic increases when the duty ratio is shifted from 50%. Therefore, the target duty ratio is set to 50%.

In still another manner, the above information recording reproduction apparatus may further include a radiation amount measuring unit which measures radiation amount of the higher harmonic component due to the high frequency signal, and the duty controlling unit may control the duty ratio so that the measured radiation amount becomes minimum.

In this manner, by measuring the radiation amount of the higher harmonic component due to the high frequency signal by the radiation amount measuring unit, the information recording reproduction apparatus executes the control in order to set the duty ratio at which the radiation amount becomes minimum. Thereby, it becomes possible to effectively reduce the generation of the unnecessary radiation caused by the high frequency superimposition.

In still another manner of the above information recording reproduction apparatus, the duty controlling unit may control the duty ratio so that the duty ratio becomes a duty ratio obtained in a case that the radiation amount determined by measuring the radiation amount of the higher harmonic component due to the high frequency signal in advance becomes minimum.

In this manner, the information recording reproduction apparatus measures the radiation amount in advance by using an external apparatus, and determines the duty ratio at which the radiation amount becomes minimum to execute the control so that the duty ratio of the high frequency signal becomes the duty ratio. Thereby, it becomes possible to reduce the generation of the unnecessary radiation due to the high frequency superimposition. Further, it is unnecessary that a processing unit detecting the duty ratio and a processing unit measuring the radiation amount are provided in the information recording reproduction apparatus. Therefore, the configuration of the apparatus can be simplified, which can lower the cost.

According to another aspect of the present invention, there is provided an information reproduction method which reproduces information recorded on an optical disc, including: a process which superimposes a high frequency signal on a laser driving signal; a process which supplies the laser driving signal on which the high frequency signal is superimposed to a laser light source to make the laser light source emit a laser light; and a duty controlling process which controls a duty ratio of the high frequency signal. According to the above information reproduction method, it becomes possible to reduce the generation of the unnecessary radiation due to the high frequency signal, too.

The nature, utility, and further features of this invention will be more clearly apparent from the following detailed description with respect to preferred embodiment of the invention when read in conjunction with the accompanying drawings briefly described below.

### BRIEF DESCRIPTION OF THE DRAWINGS

FIG. 1 is a block diagram schematically showing a configuration of an information recording reproduction apparatus according to a first embodiment of the present invention;

FIG. 2 is a block diagram schematically showing a configuration of a duty controlling unit and a duty detecting unit according to a first configuration example;

FIGS. 3A and 3B are diagrams for explaining a relation between a value outputted from the duty detecting unit and a duty ratio in the first configuration example;

FIG. 4 is a block diagram schematically showing a configuration of a duty controlling unit and a duty detecting unit according to a second configuration example;

FIGS. 5A and 5B are diagrams for explaining a relation between a value outputted from the duty detecting unit and the duty ratio in the second configuration example;

FIGS. 6A and 6B are frequency spectra for explaining a target duty ratio of a high frequency signal;

FIG. 7 is a block diagram of simulation for executing calculation of adding a secondary higher harmonic to a fundamental frequency;

FIGS. 8A to 8C are waveform diagrams showing results of the simulation shown in FIG. 7;

FIG. 9 is a block diagram schematically showing a configuration of the information recording reproduction apparatus according to a second embodiment of the present invention; and

FIG. 10 is a block diagram schematically showing a configuration of the information recording reproduction apparatus according to a third embodiment of the present invention.

### DETAILED DESCRIPTION OF THE PREFERRED EMBODIMENTS

The preferred embodiments of the present invention will now be described below with reference to the attached drawings.

### First Embodiment

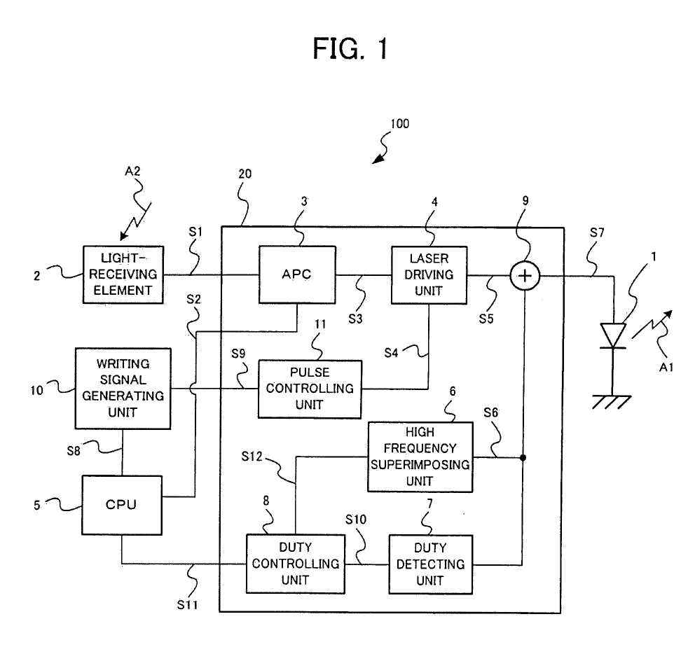

First, a description will be given of a configuration of an information recording reproduction apparatus according to a first embodiment of the present invention with reference to FIG. 1.

FIG. 1 is a block diagram schematically showing a configuration of an information recording reproduction apparatus 100. The information recording reproduction apparatus 100 mainly includes a laser diode 1, a light-receiving element 2, an APC (Automatic Power Controller) 3, a laser driving unit 4, a CPU (Central Processing Unit) 5, a high frequency superimposing unit 6, a duty detecting unit 7, a duty controlling unit 8, an adder 9, a writing signal generating unit 10 and a pulse controlling unit 11. The information recording reproduction apparatus 100 reproduces information recorded on an optical disc (not shown) and records the information onto the optical disc. It is noted that the APC 3, the laser driving unit 4, the high frequency super imposing unit 6, the duty detecting unit 7, the duty controlling unit 8, the adder 9 and the pulse controlling unit 11 are configured as one LSI 20.

The laser diode 1 emits a light beam to the optical disc. The light beam (arrow A1) emitted from the laser diode 1 passes through an optical system such as a mirror and a prism to be finally collected onto a recording surface of the optical disc by an objective lens.

Meanwhile, a part (e.g., 1%) of the light beam (arrow A1) emitted from the laser diode 1 is reflected by the optical system such as the prism to be incident on the light-receiving element 2, as shown by an arrow A2.

The light-receiving element 2 receives the part of the light beam emitted by the laser diode 1, as shown by the arrow A2. The light-receiving element 2 outputs, to the APC 3, a signal S1 corresponding to a laser power of the received light beam. The APC 3 compares the signal S1 supplied from the light-receiving element 2 and a signal S2 corresponding to a target laser power supplied from the CPU 5. Then, the APC 3 supplies, to the laser driving unit 4, a driving signal S3 according to the comparative result.

In this case, when the laser power detected in the light-receiving element 2 is larger than the target laser power, the APC 3 outputs the driving signal S3 making the laser power emitted by the laser diode 1 small. Meanwhile, when the laser power detected in the light-receiving element 2 is smaller than the target laser power, the APC 3 outputs the driving signal S3 making the laser power emitted by the laser diode 1 large. In this manner, the APC 3 executes negative feedback control so that the light beam of the target laser power is emitted from the laser diode 1.

The laser driving unit 4 has a function of controlling the laser power of the light beam emitted by the laser diode 1. In this case, the laser driving unit 4 outputs a control signal S5 to the adder 9 based on the driving signal S3 supplied from the APC 3 and a recording pulse signal S4 supplied from the pulse controlling unit 11.

At the time of reproducing data, the adder 9 supplies, to the laser diode 1, a signal S7 obtained by adding the control signal S5 supplied from the laser driving unit 4 and a high frequency signal (high frequency current) S6 supplied from the high frequency superimposing unit 6. Meanwhile, at a time of recording the data, since the high frequency signal S6 is not supplied, the adder 9 supplies the control signal S5 to the laser diode 1 as the signal S7. The laser diode 1 outputs the light beam of the laser power corresponding to the signal S7 supplied from the adder 9.

At the time of recording the data, the writing signal generating unit 10 receives a command from the CPU 5 by a signal S8. In this case, the writing signal generating unit 10 generates recording data, and subsequently generates digital modulation data such as EFM (Eight to Fourteen Modulation) suitable for the recording onto the optical disc. The modulation data is supplied to the pulse controlling unit 11 as an NRZI (Non Return to Zero Inverted) signal S9.

When obtaining the NRZI signal S9, the pulse controlling unit 11 generates the recording pulse corresponding to marks and spaces, and supplies, to the laser driving unit 4, the recording pulse signal S4 having the current amount which is set in advance by the CPU 5.

At the time of reproducing the data, the high frequency superimposing unit 6 supplies the high frequency signal S6 having the frequency of several hundreds MHz to the adder 9. Meanwhile, at the time of recording the data, the high frequency superimposing unit 6 stops the generation of the high frequency signal S6 based on the command from the CPU 5. Therefore, at the time of reproducing the data, in the adder 9, the high frequency signal S6 outputted from the high frequency superimposing unit 6 is superimposed on the control signal S5 outputted from the laser driving unit 4 (i.e., the high frequency superimposition). Thereby, since the laser diode 1 is oscillated in a multimode by the high frequency signal S6, instability due to the return light from the optical disc is removed, and the stable oscillating state can be obtained.

The duty detecting unit 7 obtains the high frequency signal S6 outputted from the high frequency superimposing unit 6 and detects the duty ratio of the high frequency signal S6. Then, the duty detecting unit 7 supplies, to the duty controlling unit 8, a duty detecting signal S10 corresponding to the detected duty ratio.

The duty detecting signal S1 corresponding to the detected duty ratio and a signal S11 corresponding to the target duty ratio from the CPU 5 are supplied to the duty controlling unit 8. The duty controlling unit 8 compares the detected duty ratio and the target duty ratio, and supplies a duty control signal S12 to the high frequency superimposing unit 6 so that the high frequency signal S6 outputted from the high frequency superimposing unit 6 coincides with the target duty ratio. The high frequency superimposing unit 6 oscillates the high frequency signal S6 with the duty ratio corresponding to the supplied duty control signal S12.

Next, a description will be given of the concrete configuration of the above-mentioned duty detecting unit 7 and duty controlling unit 8.

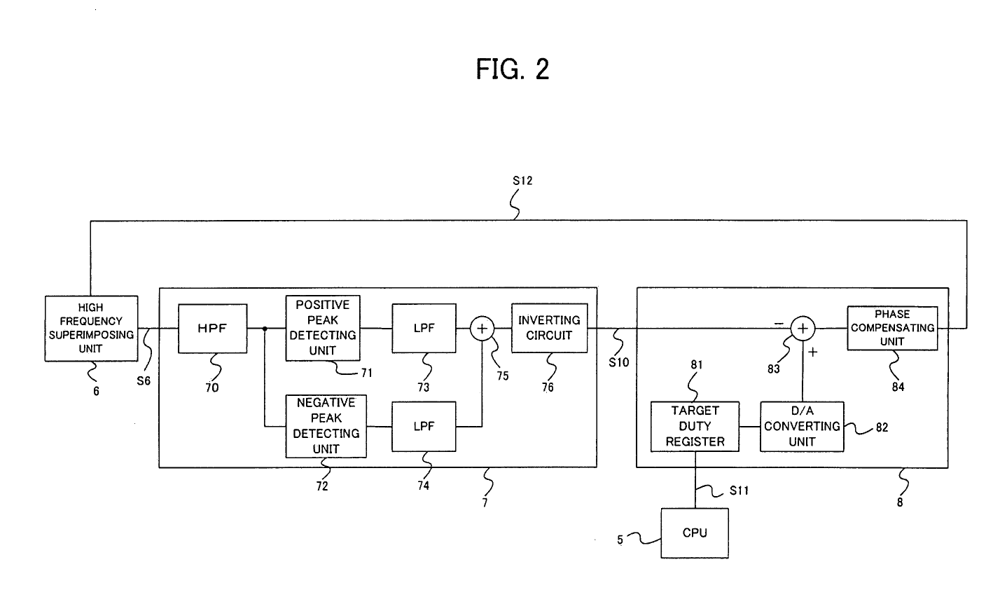

First, a description will be given of a first configuration example of the duty detecting unit 7 and the duty controlling unit 8. FIG. 2 is a block diagram schematically showing the configuration of the duty detecting unit 7 and the duty controlling unit 8 according to the first configuration example.

The duty detecting unit 7 includes an HPF (High Pass Filter) 70, a positive peak detecting unit 71, a negative peak detecting unit 72, LPFs (Low Pass Filters) 73 and 74, an adder 75 and an inverting circuit 76. The high frequency signal S6 outputted by the high frequency superimposing unit 6 is inputted to the duty detecting unit 7. A direct current component of the inputted high frequency signal S6 is removed by the HPF 70, and a positive peak detecting signal and a negative peak detecting signal thereof are detected by the positive peak detecting unit 71 and the negative peak detecting unit 72. The detected positive and negative peak detecting signals pass the LPFs 73 and 74, respectively, by which ripple components thereof is suppressed, and the signals are inputted to the adder 75. The adder 75 adds the inputted signals, and the polarity of the added signal is inverted in the inverting circuit 76. Then, the signal is outputted to the duty controlling unit 8 as the duty detecting signal S10.

The duty controlling unit 8 includes a target duty register 81, a D/A converting unit 82, a subtracter 83 and a phase compensating unit 84. The target duty register 81 obtains the signal S11 corresponding to the target duty ratio supplied from the CPU 5 and stores the obtained target duty ratio. The signal outputted from the target duty register 81 is inputted to the D/A converting unit 82 to be D/A-converted. The subtracter 83 outputs, to the phase compensating unit 84, a signal obtained by subtracting the duty detecting signal S10 supplied from the duty detecting unit 7 from an analog signal corresponding to the target duty ratio supplied from the D/A converting unit 82. The phase compensating unit 84 may include an integrating circuit, for example. In this case, the phase compensating unit 84 executes, to the signal supplied from the subtracter 83, phase compensation such as integral in order to be suitable for control operation of the high frequency superimposing unit 6, and supplies a value after the phase compensation to the high frequency superimposing unit 6 as the duty control signal S12.

In this manner, when the detected duty ratio is larger than the target duty ratio by the process in the duty detecting unit 7 and the duty controlling unit 8, the duty ratio of the high frequency signal S6 outputted by the high frequency superimposing unit 6 is controlled to be small. Meanwhile, when the detected duty ratio is smaller than the target duty ratio, the duty ratio of the high frequency signal S6 is controlled to be large. Namely, the duty detecting unit 7 and the duty controlling unit 8 execute the negative feedback control so that the duty ratio of the high frequency signal S6 outputted from the high frequency superimposing unit 6 coincides with the target duty ratio. Thereby, it can be prevented that the duty ratio is shifted from the target duty ratio due to the aged variation and temperature change.

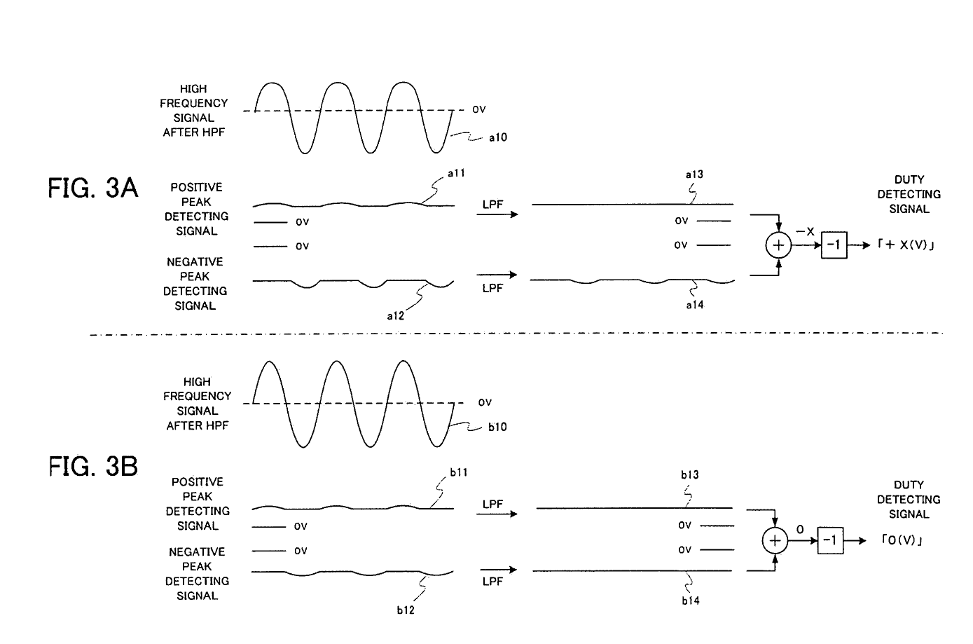

Now, a concrete description will be given of a relation between the value outputted from the duty detecting unit 7 in the first configuration example and the duty ratio of the high frequency signal with reference to FIGS. 3A and 3B. In FIGS. 3A and 3B, the target duty ratio is set to 50%.

FIG. 3A shows a waveform obtained in the case that the duty ratio of the high frequency signal is shifted from 50% (to a value larger than 50%), i.e., in the case that the duty ratio of the high frequency signal is shifted from the target duty ratio. A waveform a10 shows the high frequency signal after the process in the HPF 70. By detecting the high frequency signal a10 after the HPF in the positive peak detecting unit 71, a positive peak detecting signal a11 is obtained. Similarly, by detecting the high frequency signal a10 in the negative peak detecting unit 72, a negative peak detecting signal a12 is obtained. It is understood that output magnitude of the positive peak detecting signal a11 is smaller than output magnitude of the negative peak detecting signal a12 in this case. Next, by processing the positive peak detecting signal a11 and the negative peak detecting signal a12 by the LPFs 73 and 74, waveforms shown by reference numerals a13 and a14 are obtained. By adding them by the adder 75 and inverting the polarity of the added signal by the inverting circuit 76, “+X (V)” (X>0) is obtained as output (duty detecting signal S10). Since the output magnitude of the positive peak detecting signal a11 is not equal to the output magnitude of the negative peak detecting signal a12, the output does not become “0(V)”. When the output magnitude of the positive peak detecting signal a11 is larger than the output magnitude of the negative peak detecting signal a12, a positive voltage is outputted from the adder 75, and a negative voltage is outputted from the inverting circuit 76.

FIG. 3B shows a waveform obtained in the case that the duty ratio of the high frequency signal coincides with 50%, i.e., in the case that the duty ratio of the high frequency signal coincides with the target duty ratio. A waveform b10 shows the high frequency signal after the process in the HPF 70. By detecting a high frequency signal b10 after the HPF in the positive peak detecting unit 71, a positive peak detecting signal b11 is obtained. By detecting the high frequency signal b10 in the negative peak detecting unit 72, the negative peak detecting signal b12 is obtained. In this case, it is understood that the output magnitude of the positive peak detecting signal b11 and the output magnitude of the negative peak detecting signal b12 are almost same. Next, by processing the positive peak detecting signal b11 and the negative peak detecting signal b12 in the LPFs 73 and 74, waveforms shown by reference numerals b13 and b14 are obtained. By adding them by the adder 75 and inverting the polarity of the added signal by the inverting circuit 76, “0 (V)” is obtained as the output (duty detecting signal S10). Since the output magnitude of the positive peak detecting signal b11 and the output magnitude of the negative peak detecting signal b12 are equal, “0(V)” is obtained as the output. In the case of the duty detecting unit according to the first configuration example, since the above-mentioned HPF 70 can be realized by a simple coupling using a condenser, the configuration of the detecting unit can be advantageously simplified.

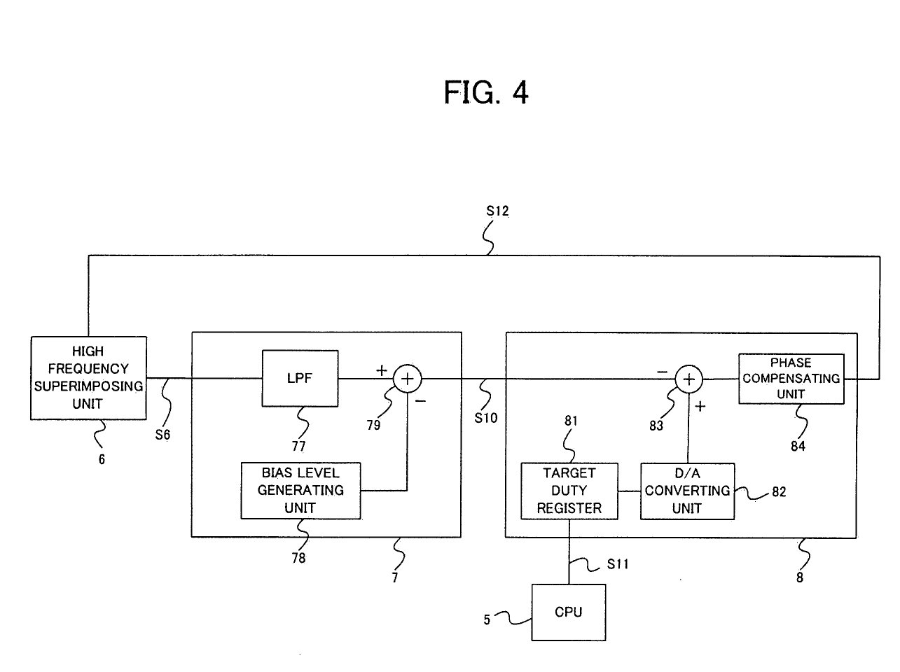

Next, a description will be given of a second configuration example of the above-mentioned duty detecting unit 7 and duty controlling unit 8 with reference to FIG. 4.

FIG. 4 is a block diagram schematically showing the configuration of the duty detecting unit 7 and the duty controlling unit 8 according to the second configuration example.

The duty detecting unit 7 includes an LPF 77, a bias level generating unit 78 and a subtracter 79. The high frequency signal S6 outputted by the high frequency superimposing unit 6 is inputted to the duty detecting unit 7. A high frequency component of the inputted high frequency signal S6 is removed by the LPF 77, and the direct current component thereof is extracted to be inputted to a positive terminal of the subtracter 79. Meanwhile, the bias level generating unit 78 generates the bias level signal serving as a reference level (hereinafter, referred to as “reference bias level”) of the high frequency superimposing signal S6, which is inputted to the negative terminal being another terminal of the subtracter 79. The subtracter 79 calculates the shift from the reference bias level of the high frequency superimposing signal S6 to output it to the duty controlling unit 8 as the duty detecting signal S10. The configuration and operation of the duty controlling unit 8 are same as those of the above-mentioned first configuration example, and an explanation thereof is omitted.

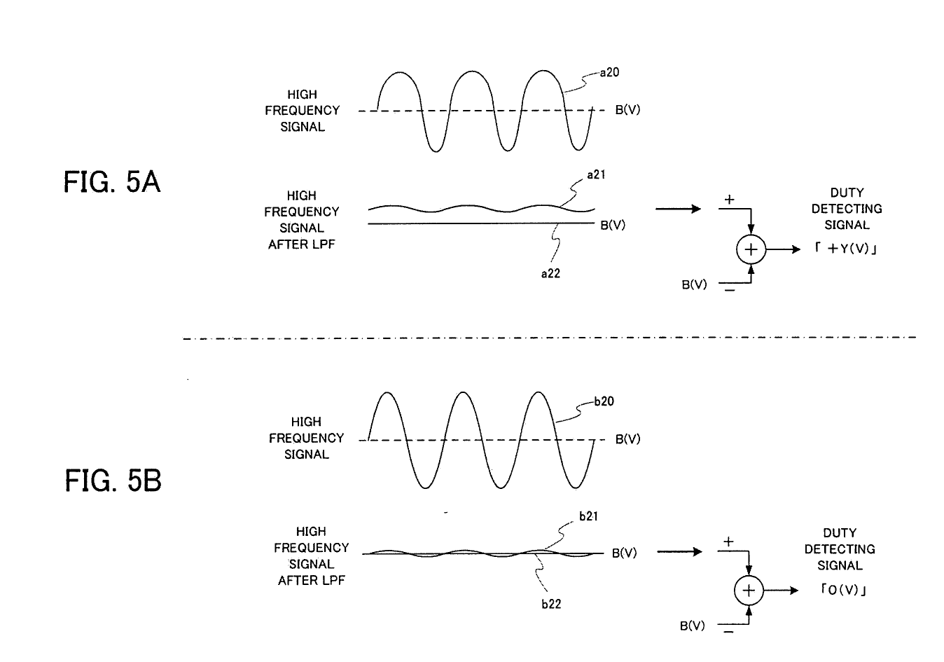

Now, a concrete description will be given of a relation between a value outputted from the duty detecting unit 7 according to the second configuration example and the duty ratio of the high frequency signal with reference to FIGS. 5A and 5B. It is noted that the target duty ratio is set to 50% in FIGS. 5A and 5B. The duty detecting unit of the second configuration example is advantageously suitable in that the coupling by the condenser is not used in a case that the high frequency superimposing device of the present invention is integrated as an integrated circuit as a whole.

FIG. 5A shows the waveform obtained in the case that the duty ratio of the high frequency signal is shifted from 50% (to a value larger than 50%), i.e., in the case that the duty ratio of the high frequency signal is shifted from the target duty ratio. The waveform a20 shows the high frequency signal. By removing the high frequency component of the high frequency signal a20 by the LPF 77, a signal a21 is obtained in which direct current component of the high frequency signal a20 is extracted. It is understood that a DC level in the signal a21 is larger than a level (B(V)) of the bias level signal a22 generated by the bias level generating unit 78. Therefore, “+Y(V)” (Y>0) is obtained as the output (duty detecting signal S10) of the subtracter 79. Since the high frequency signal is shifted from the reference bias level, the output is not “0(V)” like this. At this time, the waveform of the high frequency signal is distorted due to the bias shift. Concretely, the duty ratio of the high frequency signal is shift from 50%.

FIG. 5B shows the waveform obtained in the case that the duty ratio of the high frequency signal coincides with 50%, i.e., in the case that the duty ratio of the high frequency signal coincides with the target duty ratio. The waveform b20 shows the high frequency signal. By removing the high frequency component of the high frequency signal b20 by the LPF 77, a signal b21 is obtained in which direct current component of the high frequency signal b20 is extracted. It is understood that the DC level of the signal b21 is almost same as the level (B(V)) of a bias level signal b22 generated by the bias level generating unit 78. Therefore, “0(V)” is obtained as the output (duty detecting signal S10) of the subtracter 79. Since the DC level of the high frequency signal is equal to the reference bias level, “0(V)” is obtained as the output.

In this manner, when the duty ratio of the high frequency signal coincides with 50% (target duty ratio), the duty detecting signal S10 outputted by the duty detecting unit 7 becomes “0(V)”. When the duty ratio of the high frequency signal is shifted from 50% (target duty ratio), the duty detecting signal S10 does not become “0(V)”. Namely, when the duty ratio of the high frequency signal is shifted from 50% (target duty ratio), the duty detecting unit 7 outputs the voltage corresponding to the shift amount as the duty detecting signal S10. The polarity of the duty detecting signal S10 indicates such a direction that the duty ratio of the high frequency signal is shifted from the target duty ratio (i.e., whether the duty ratio is larger or smaller than the target duty ratio), and an absolute value of the duty detecting signal S10 indicates the shift amount.

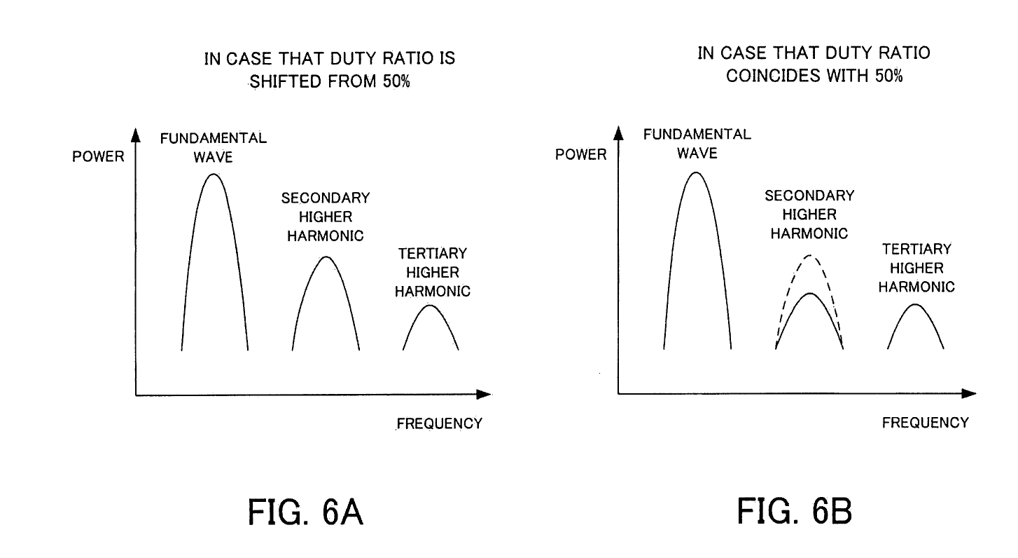

The target duty ratio of the high frequency signal will be explained with reference to FIGS. 6A and 6B.

FIGS. 6A and 6B show frequency spectra of the high frequency signals. The horizontal axis indicates the frequency of the wave, and the vertical axis indicates the power (intensity) thereof. In FIGS. 6A and 6B, powers of a fundamental wave of the high frequency signal, a wave of a second-order component (secondary higher harmonic) and a wave of a third-order component (tertiary (third-order) higher harmonic) are shown from left to right of the diagrams. Since the frequency of the fundamental wave of the high frequency signal is set to several hundreds MHz, the frequency of the secondary higher harmonic becomes the order of GHz. Thus, when the powers of the secondary higher harmonic and the tertiary higher harmonic are large, the unnecessary radiation tends to increase.

FIG. 6A shows the spectra of the frequencies in the case of the actual duty ratio of the high frequency signal is shifted from 50%, and FIG. 6B shows the spectra of the frequencies in the case that the actual duty ratio of the high frequency signal is around 50%. A broken line in FIG. 6B shows the spectrum of the frequency in the case that the duty ratio of the high frequency signal is shifted from 50%, which is shown in an overlapped manner. FIG. 6A shows the spectrum obtained in the case that the duty control is not executed and the duty ratio is shifted from 50% due to irregularity of elements, a temperature characteristic and the aged variation.

From FIGS. 6A and 6B, it is understood that the power of the secondary higher harmonic is large when the duty ratio is shifted from 50% and that the power of the secondary higher harmonic is small when the duty ratio coincides with 50%. Namely, it is understood that when the duty ratio coincides with 50%, the generation of a high-order harmonic such as the secondary higher harmonic is suppressed as compared with the case that the duty ratio is shifted from 50%. Specifically, it becomes possible to suppress the generation of the even-order higher harmonic.

Therefore, by setting the target duty ratio to 50% and executing the control to make the duty ratio coincide with the target duty ratio, it becomes possible to suppress the generation of the even-order higher harmonic such as the secondary higher harmonic. Thereby, it becomes possible to effectively suppress the generation of the unnecessary radiation caused by the high frequency superimposition.

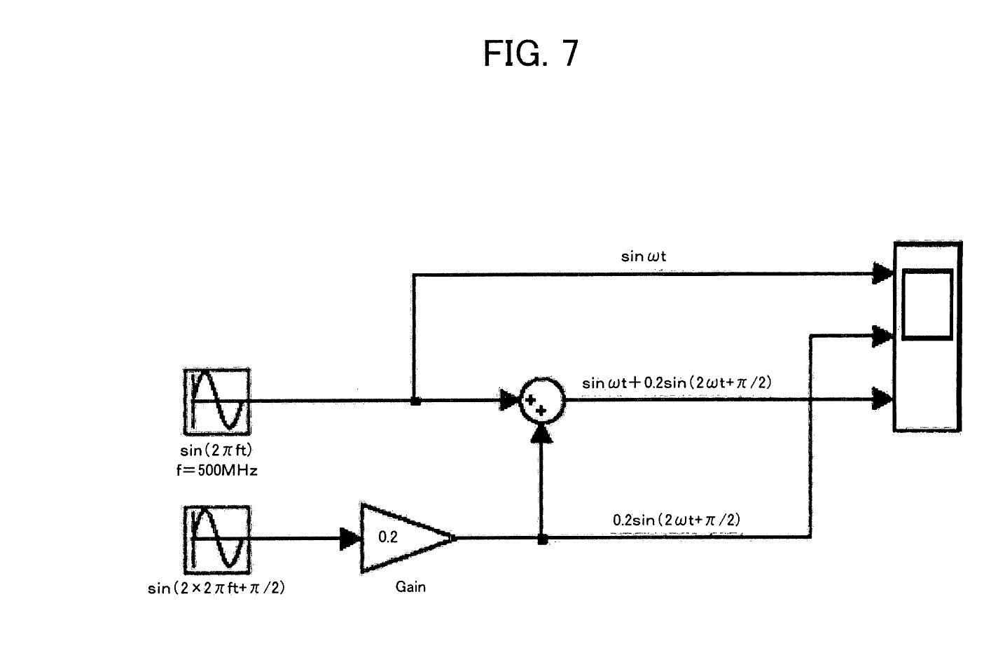

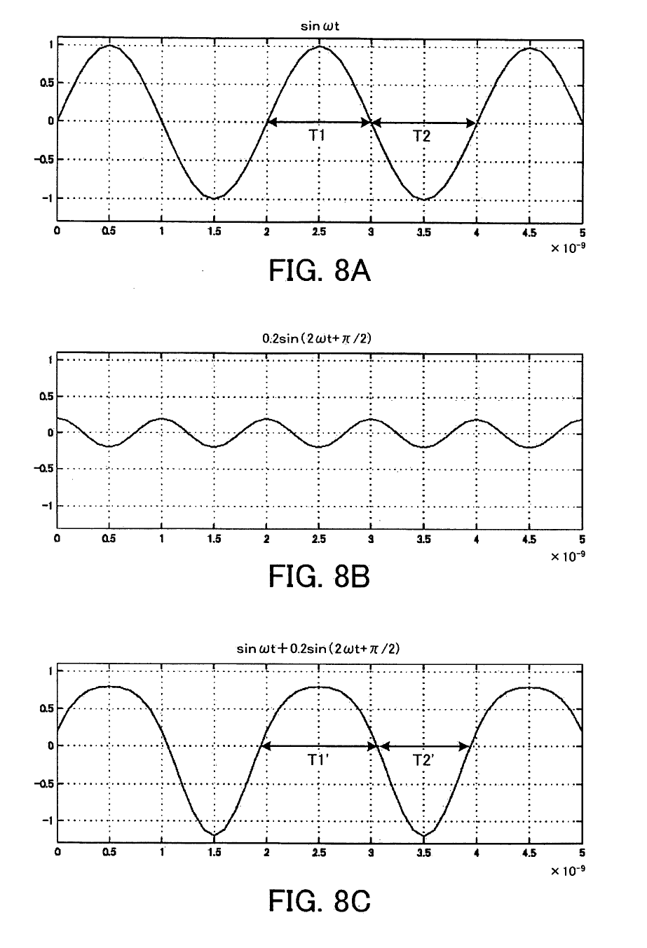

Now, a concrete description will be given of the reason why the generation of the higher harmonic is suppressed by setting the duty ratio of the high frequency signal to 50%, with reference to FIG. 7 and FIGS. 8A to 8C.

FIG. 7 shows a block diagram of a simulation for executing calculation of adding the secondary higher harmonic to the fundamental wave. In this case, “sin ωt” is used as the fundamental wave, and “0.2 sin(2 ωt+π/2)” is used as the secondary higher harmonic. A wave having comparatively large magnitude is used for the secondary higher harmonic.

FIGS. 8A to 8C are waveforms showing the result of the simulation shown in FIG. 7. FIG. 8A shows the waveform of the fundamental wave, FIG. 8B shows the waveform of the secondary higher harmonic, and FIG. 8C shows the waveform obtained by adding the fundamental wave and the secondary higher harmonic. In this case, as for the fundamental wave, a period in which the output shows positive is same as a period in which the output shows negative (i.e., T1=T2). Meanwhile, as understood from the waveform shown in FIG. 8C, in this simulation example, it is understood that the negative period of the wave obtained by adding the fundamental wave and the secondary higher harmonic is shorter than the positive period thereof (i.e., T1′>T2′) and the duty ratio is shifted from 50%. This is because the secondary higher harmonic having the comparatively large magnitude is added to the fundamental wave in this simulation. Conversely, when the secondary higher harmonic having the comparatively small magnitude is added to the fundamental wave, the duty ratio becomes approximately 50%.

According to the above result, it can be said that as the duty ratio is shifted farther from 50%, the power of the secondary higher harmonic increases more and that when the duty ratio is around 50%, the power of the secondary higher harmonic is small. Therefore, in this embodiment, the target duty ratio is set to 50%, and the duty ratio is controlled so that the duty ratio of the high frequency signal becomes 50%. Thereby, it becomes possible to suppress the generation of the higher harmonic in accordance with the high frequency superimposition, and as a result, it becomes possible to decrease the unnecessary radiation.

Logically, the target duty ratio is optimally 50%. However, in the actual apparatus, due to the characteristic of the oscillator, the duty ratio at which the secondary higher harmonic component becomes minimum is not always 50%. In this case, the duty ratio (e.g., 51%) at which the secondary higher harmonic component becomes minimum may be set to the target duty ratio in each apparatus.

### Second Embodiment

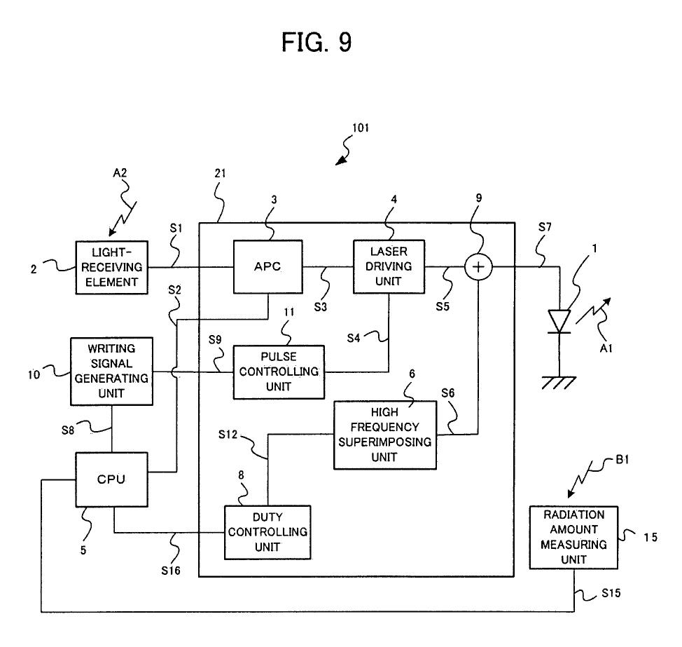

Next, a description will be given of the configuration of the information recording reproduction apparatus according to a second embodiment of the present invention with reference to FIG. 9.

FIG. 9 is a block diagram schematically showing a configuration of an information recording reproduction apparatus 101 according to the second embodiment. The information recording reproduction apparatus 101 according to the second embodiment includes a radiation amount measuring unit 15, unlike the information recording reproduction apparatus 100 according to the first embodiment. In addition, an LSI 21 in the information recording reproduction apparatus 101 does not have the duty detecting unit 7, unlike the LSI 20. The same reference numerals are given to the same components and signals as those of the above-mentioned information recording reproduction apparatus 100, and explanations thereof are omitted.

In the information recording reproduction apparatus 101 according to the second embodiment, the radiation amount measuring unit 15 actually measures the radiation amount by the high frequency signal S6 outputted by the high frequency superimposing unit 6. Based on the measured radiation amount, the duty control is executed to maintain the optimum duty ratio. Concretely, the radiation amount measuring unit 15 obtains the secondary higher harmonic component of the radiated high frequency signal S6 with an antenna as shown by an arrow B1, and measures the radiation amount. The radiation amount measuring unit 15 supplies a signal S15 corresponding to the measured radiation amount to the CPU 5.

Based on the signal S15 supplied from the radiation amount measuring unit 15, the CPU 5 supplies a signal S16 to the duty controlling unit 8 as a duty command. Concretely, the CPU 5 issues a stepwise signal to the duty controlling unit 8 as the duty command (i.e., the control is executed so that the duty ratio of the high frequency signal S6 outputted by the high frequency superimposing unit 6 increases or decreases stepwise). At the same time, the CPU 5 produces a table associating the issued duty command with the measured radiation amount in one-to-one correspondence. Finally, the CPU 5 issues, again to the duty controlling unit 8, the duty command determined to correspond to the smallest radiation amount based on the produced table. Thereby, the duty ratio of the high frequency signal S6 outputted from the high frequency superimposing unit 6 is set to the duty ratio in the case of the smallest radiation amount. The duty ratio in the case of the smallest radiation amount becomes approximately 50%.

In this manner, by measuring the radiation amount in the radiation amount measuring unit 15, the information recording reproduction apparatus 101 according to the second embodiment determines the optimum duty ratio with the smallest radiation amount and sets the duty ratio of the high frequency signal S6 outputted from the high frequency superimposing unit 6 to the optimum duty ratio. By setting the duty ratio to the optimum duty ratio thus determined, it becomes possible to suppress the generation of the unnecessary radiation due to the high frequency superimposition. Since the generation of the unnecessary radiation is mainly caused due to the secondary higher harmonic, by setting the duty ratio to the duty ratio decreasing the unnecessary radiation, the generation of the secondary higher harmonic also decreases.

Moreover, since the information recording reproduction apparatus 101 according to the second embodiment does not have to include the duty detecting unit 7 in the LSI 21, it becomes possible to lower the cost as compared with the information recording reproduction apparatus 100 according to the first embodiment.

### Third Embodiment

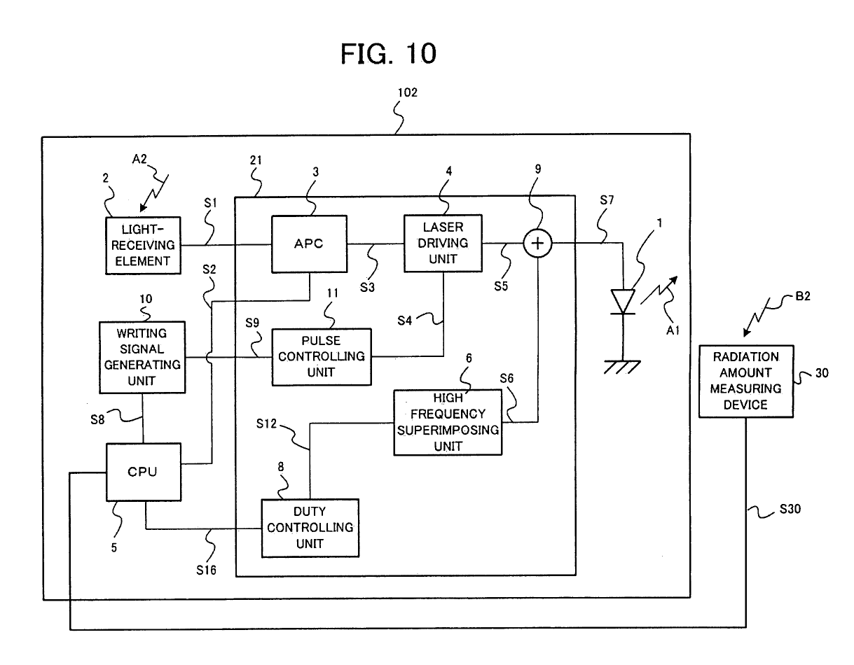

Next, a description will be given of a configuration of the information recording reproduction apparatus according to a third embodiment of the present invention with reference to FIG. 10. In the first and second embodiments, the information recording reproduction apparatus includes the duty controlling unit for controlling the duty ratio of the high frequency signal in its inside. Namely, the first and second embodiments are embodiments in a case that the information recording reproduction apparatus independently has a duty controlling function. Meanwhile, the third embodiment which will be explained below is an example in which the present invention is applied to a system of performing adjustment before the shipment of the information recording reproduction apparatus from a factory, and a part of the duty controlling unit is provided outside of the information recording reproduction apparatus.

FIG. 10 is a block diagram schematically showing the configuration of an information recording reproduction apparatus 102. Unlike the information recording reproduction apparatus 101 according to the second embodiment, the information recording reproduction apparatus 102 according to the third embodiment does not include the radiation amount measuring unit 15. The same reference numerals are given to the same components and signals as those of the above-mentioned information recording reproduction apparatuses 100 and 101, and explanations thereof are omitted.

In the information recording reproduction apparatus 102 according to the third embodiment, the radiation amount of the high frequency signal S6 outputted from the high frequency superimposing unit 6 is measured by the radiation amount measuring device 30 externally arranged, and based on the measured radiation amount, the duty control is executed. More concretely, the radiation amount by the higher harmonic component of the high frequency signal S6 is measured in advance by the radiation amount measuring device 30, and based on the measured result, the duty control is executed to determine the optimum duty ratio.

Similarly to the above-mentioned radiation amount measuring unit 15, the radiation amount measuring device 30 obtains the radiated secondary higher harmonic component with the antenna as shown by an arrow B2 and measures the radiation amount. Then, the radiation amount measuring unit 30 supplies the measured radiation amount to the CPU 5 in the information recording reproduction apparatus 102 by a signal line S30.

Based on the radiation amount measured in the radiation amount measuring device 30, the CPU 5 supplies the signal S16 to the duty controlling unit 8 as the duty command. Concretely, the CPU 5 issues the stepwise signal to the duty controlling unit 8 as the duty command, and produces the table associating the issued duty command with the measured radiation amount in one-to-one correspondence. Finally, the CPU 5 issues, again to the duty controlling unit 8, the duty command determined to correspond to the smallest radiation amount based on the produced table. Thereby, the duty ratio of the high frequency signal S6 outputted from the high frequency superimposing unit 6 is set to the duty ratio in the case of the smallest radiation amount. It is noted that the duty ratio in the case of the smallest radiation amount becomes approximately 50%.

In this manner, by measuring the radiation amount with the radiation amount measuring device 30, the information recording reproduction apparatus 102 according to the third embodiment determines the optimum duty ratio with the smallest radiation amount and sets the duty ratio of the high frequency signal S6 outputted from the high frequency superimposing unit 6 to the optimum duty ratio. Thereby, it becomes possible to reduce the generation of the unnecessary radiation due to the high frequency superimposition, too. Moreover, the information recording reproduction apparatus 102 according to the third embodiment does not have to include the radiation amount measuring unit 15 and the duty detecting unit 7 in its inside. Therefore, the configuration of the information recording reproduction apparatus 102 is simplified as compared with the above-mentioned information recording reproduction apparatuses 100 and 101, and it becomes possible to lower the cost. Setting the duty ratio with using the radiation amount measuring device 30 can be executed before the shipment of the information recording reproduction apparatus 100 from the factory.

[Modification]

In the above-mentioned second and third embodiments, as the radiation amount measuring unit 15 and the radiation amount measuring device 30, the example of measuring the radiation amount by the antenna is shown. However, instead of the antenna, by providing a current measuring resistance on a substrate in the information recording reproduction apparatuses 101 and 102 and using it, the radiation amount can be measured. For example, by connecting the current measuring resistance in series with the laser diode 1 and detecting the current supplied to the laser diode 1, or by detecting a power supply current supplied to the laser driving unit 4, the radiation amount can be measured. As still another example, instead of the antenna and the current measuring resistance, the radiation amount can be measured by using a BPF (Band Pass Filter). In this case, by making a power supply voltage supplied to the laser driving unit 4 pass the BPF, only the secondary higher harmonic component in the high frequency signal passes through the BPF and other component is suppressed by the BPF. Thereby, the radiation amount can be extracted.

Moreover, such an example that the stepwise signal is issued to the duty controlling unit 8 in order to obtain the optimum duty ratio and the duty control is executed is described in the above-mentioned second and third embodiments. Instead, the duty command which the CPU 5 supplies to the duty controlling unit 8 may be periodically increased and decreased, and the radiation amount may be determined at all times. In this manner, the duty control (the so-called hill-climbing control) converging on the duty command determined to correspond to the smallest radiation amount may be executed.

The invention may be embodied on other specific forms without departing from the spirit or essential characteristics thereof. The present embodiments therefore to be considered in all respects as illustrative and not restrictive, the scope of the invention being indicated by the appended claims rather than by the foregoing description and all changes which come within the meaning an range of equivalency of the claims are therefore intended to embraced therein.

The entire disclosure of Japanese Patent Application No. 2005-035905 filed on Feb. 14, 2005 including the specification, claims, drawings and summary is incorporated herein by reference in its entirety.

What is claimed is:

1. An information recording reproduction apparatus comprising:
a laser light source;
a laser driving unit which supplies a laser driving signal to the laser light source to make the laser light source emit a laser light for recording and reproduction;
a high frequency superimposing unit which superimposes a high frequency signal on the laser driving signal; and
a duty controlling unit which controls a duty ratio of the high frequency signal.

2. The information recording reproduction apparatus according to claim 1, wherein the duty controlling unit controls the duty ratio so that generation of a higher harmonic component due to the high frequency signal is decreased.

3. The information recording reproduction apparatus according to claim 1, further comprising:
a duty detecting unit which detects a present duty ratio of the high frequency signal,
wherein the duty controlling unit controls a duty ratio so that the duty ratio detected by the duty detecting unit coincides with a predetermined target duty ratio.

4. The information recording reproduction apparatus according to claim 3, wherein the target duty ratio is set to substantially 50%.

5. The information recording reproduction apparatus according to claim 1, further comprising:
a radiation amount measuring unit which measures radiation amount of the higher harmonic component due to the high frequency signal,
wherein the duty controlling unit controls the duty ratio so that the measured radiation amount becomes minimum.

6. The information recording reproduction apparatus according to claim 1, wherein the duty controlling unit controls the duty ratio so that the duty ratio becomes a duty ratio obtained in a case that the radiation amount determined by measuring the radiation amount of the higher harmonic component due to the high frequency signal in advance becomes minimum.

7. An information reproduction method which reproduces information recorded on an optical disc, comprising:
a process which superimposes a high frequency signal on a laser driving signal;
a process which supplies the laser driving signal on which the high frequency signal is superimposed to a laser light source to make the laser light source emit a laser light; and
a duty controlling process which controls a duty ratio of the high frequency signal.
